(19) United States
(12) Patent Application Publication
(10) Pub. No.: US 2018/0309826 A1
(43) Pub. Date: Oct. 25, 2018

(54) FAULT-TOLERANT STORAGE SYSTEM USING AN ALTERNATE NETWORK

(71) Applicant: EITR Systems, Inc., San Jose, CA (US)

(72) Inventor: Raju Rangaswami, Cupertino, CA (US)

(21) Appl. No.: 15/495,643

(22) Filed: Apr. 24, 2017

(51) Int. Cl. H04L 29/08

(52) U.S. Cl. CPC H04L 67/1095; H04L 67/2804; H04L 67/1097

(57) ABSTRACT

Fault-tolerant storage can include: obtaining a write request at a first machine of a cluster of machines, each machine in the cluster enabling access to a set of target data via a primary network; initiating an update of the target data via the primary network using a set of meta-data describing the write request; and replicating the meta-data to a second machine in the cluster via an alternate network while the update via the primary network is still pending.

### BACKGROUND

A storage system can include one or more data stores for providing information storage to application programs. For example, a data center can include one or more data stores along with a set of computing resources, e.g., networks, servers, operating systems, etc., that enable application programs to update the data stores.

An application program can update a data store of a storage system by generating a write request that targets a set of data in the data store. A storage system can handle a write request by updating a data store in accordance with the write request, and then providing an acknowledgement to the application program after a completion of write request.

### SUMMARY

In general, in one aspect, the invention relates to a fault-tolerant storage system. The fault-tolerant storage system can include: a cluster of machines each enabling access to a set of target data via a primary network; and an alternate network that enables communication among the machines in the cluster; wherein a first machine in the cluster handles a write request by initiating an update of the target data via the primary network and replicating a set of meta-data describing the write request to a second machine in the cluster via the alternate network while the update via the primary network is still pending.

In general, in another aspect, the invention relates to a method for fault-tolerant storage. The method can include: obtaining a write request at a first machine of a cluster of machines, each machine in the cluster enabling access to a set of target data via a primary network; initiating an update of the target data via the primary network using a set of meta-data describing the write request; and replicating the meta-data to a second machine in the cluster via an alternate network while the update via the primary network is still pending.

Other aspects of the invention will be apparent from the following description and the appended claims.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 illustrates a fault-tolerant storage system in one or more embodiments.

FIG. 2 shows an example of how a machine in a fault-tolerant storage system handles a write request in one or more embodiments.

FIG. 3 shows an example of how a machine in a fault-tolerant storage system provides an early acknowledgement to a write request.

FIG. 4 shows an example of how a machine in a fault-tolerant storage system deletes a set of replicated meta-data from a cluster.

FIG. 5 shows an example of how a machine in a fault-tolerant storage system replicates a set of meta-data across a cluster if one or more other machines in the cluster is unavailable.

FIG. 6 shows an example of how a machine in a fault-tolerant storage system holding replicated meta-data replicates the replicated meta-data to another machine in a cluster if a machine in the cluster that originated the replicated meta-data becomes unavailable.

FIG. 7 shows an example of how a machine in a fault-tolerant storage system handles a request for a set of target data if another machine becomes unavailable while updating the target data.

FIG. 8 illustrates a coalescing buffer in a fault-tolerant storage system in one or more embodiments.

FIG. 9 illustrates a method for fault-tolerant storage in one or more embodiments.

FIG. 10 illustrates a computing system upon which portions of a fault-tolerant storage system can be implemented.

### DETAILED DESCRIPTION

Reference will now be made in detail to the various embodiments of the present disclosure, examples of which are illustrated in the accompanying drawings. Like elements in the various figures are denoted by like reference numerals for consistency. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, have not been described in detail so as not to unnecessarily obscure aspects of the present disclosure.

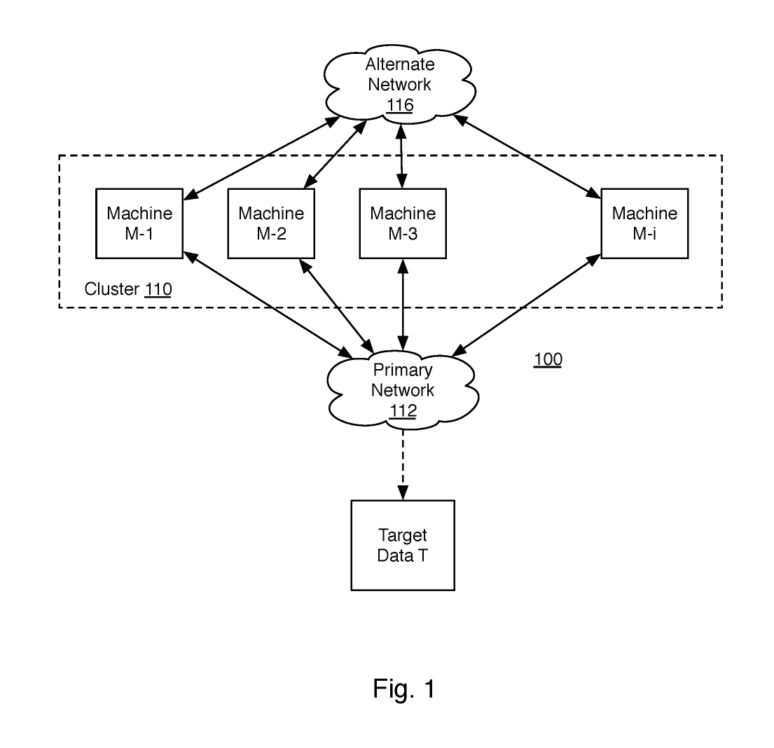

FIG. 1 illustrates a fault-tolerant storage system 100 in one or more embodiments. The fault-tolerant storage system 100 includes a cluster 110 of machines M-1 through M-i. The machines M-1 through M-i each enable access to a set of target data T via a primary network 112. The fault-tolerant storage system 100 includes an alternate network 116 that enables communication among the machines M-1 through M-i in the cluster 110.

The machines M-1 through M-i in the cluster 110 handle write requests to the target data T by initiating updates of the target data T via the primary network 112 and replicating the meta-data describing the write requests to other machines in the cluster 110 via the alternate network 116 while the corresponding updates via the primary network are still pending. For example, the machine M-1 can handle a write request by initiating an update of the target data T via the primary network 112 using a set of meta-data describing the write request and replicating the meta-data to the machine M-2 via the alternate network 116 while the update via the primary network 112 is still pending.

In one or more embodiments, the target data T can be larger than a unit read or written to any portion of the target data T. For example, the target data T can be an entire virtual disk, or an entire key-value store, or an object storage instance. The target data T can be implemented in a virtual data store or physical data store on one or more of the machines M-1 through M-i in the cluster 110 using, e.g., a scale-out or hyper-converged architecture. The target data T can be implemented in hardware separate from the cluster 110.

The machines M-1 through M-i in the cluster 110 can include any combination of physical machines and virtual machines. For example, any one or more of the machines M-1 through M-i can be a virtual machine running on shared hardware, e.g., shared computing system hardware, server system hardware, data center hardware, etc. The machines M-1 through M-i can all be separate physical machines running on their own dedicated hardware.

The primary network 112 and the alternate network 116 can be separate physical networks. The primary network 112 and the alternate network 116 can be respective virtual networks of a common physical network. The primary network 112 and the alternate network 116 can be local area networks in a data center or wide area networks that encompasses multiple data centers.

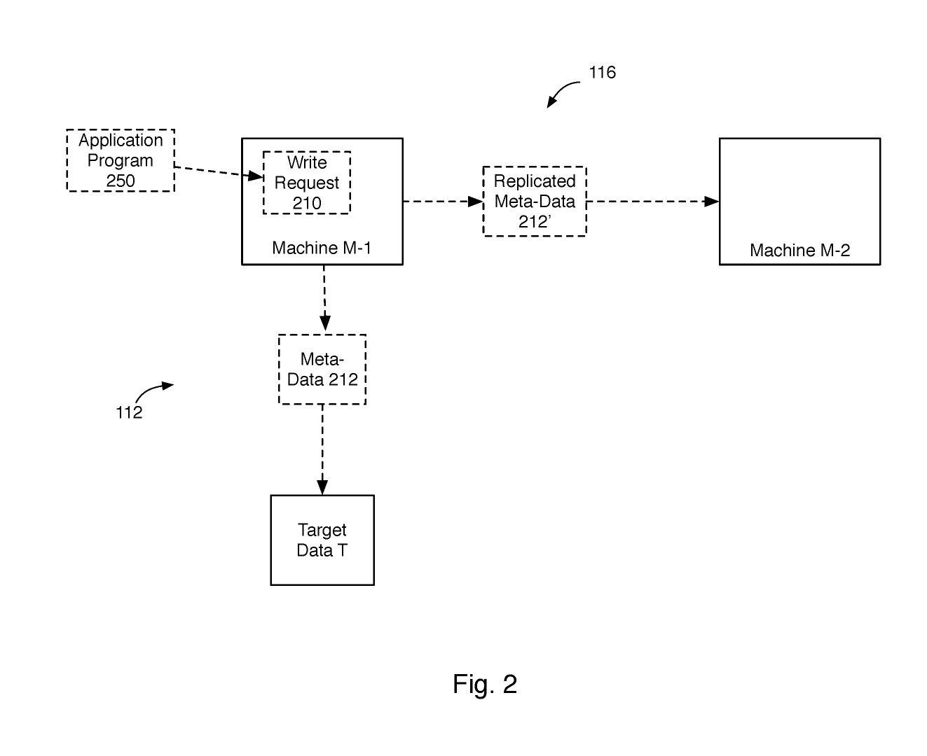

FIG. 2 shows how the machine M-1 handles a write request 210 to the target data T in one or more embodiments. In this example, the write request 210 is issued by an application program 250. The application program 250 can be running on the machine M-1. The application program 250 can be running on any of the other machines M-2 through M-i in the cluster 110, or on some other machine accessible via the primary network 112 or the alternate network 116.

The write request 210 includes a set of meta-data 212 describing the write request 210. The meta-data 212 can describe an update of a portion of the target data T or an update of all of the target data T. The meta-data 212 can include a set of data to be written to the target data T.

The machine M-1 handles the write request 210 by initiating an update of the target data T via the primary network 112 using the meta-data 212 and by replicating the meta-data 212 to the machine M-2 while the update of the target data T via the primary network 112 is still pending. The machine M-1 replicates the meta-data 212 into a set of replicated meta-data 212′ and transfers the replicated meta-data 212′ to the machine M-2 via the alternate network 116 before receiving an acknowledgement indicating a successful completion of the update of the target data T in accordance with the meta-data 212.

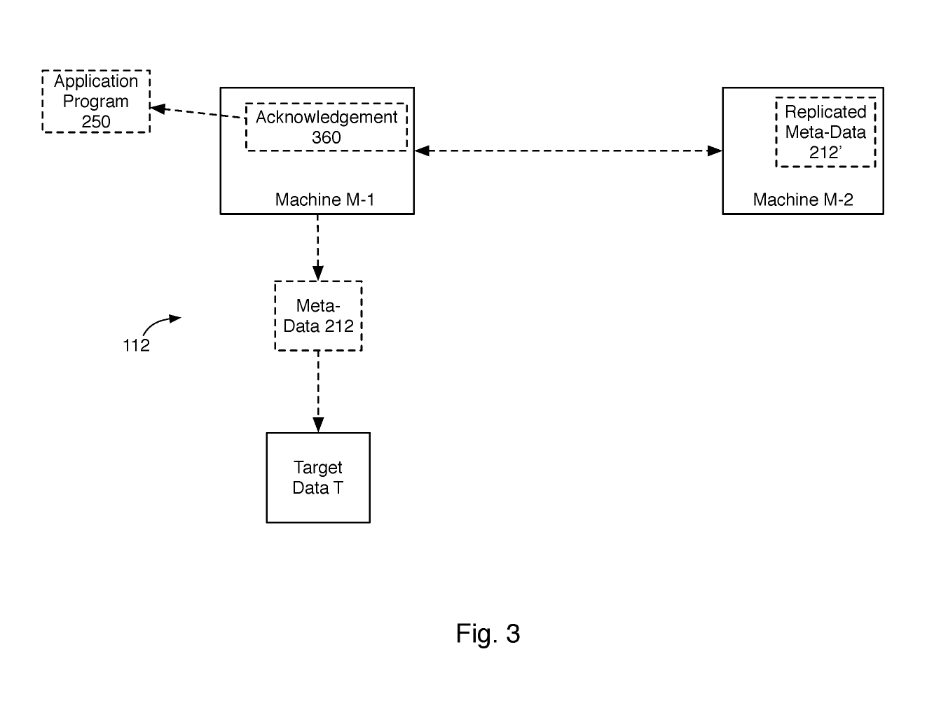

FIG. 3 shows how the machine M-1 acknowledges the write request 210 while the update of the target data T associated with the write request 210 is still pending. The machine M-1 provides an acknowledgement 360 to the application program 250 that generated the request 210 before obtaining an indication that the update of the target data T in accordance with the meta-data 212 is complete. The machine M-1 can provide the early acknowledgement 360 to the application program 250 because the replicated meta-data 212′ for the write request 210 is safely stored on the machine M-2. The early acknowledgement 360 can significantly reduce the input/output latency for the application program 250 that issued the request 210.

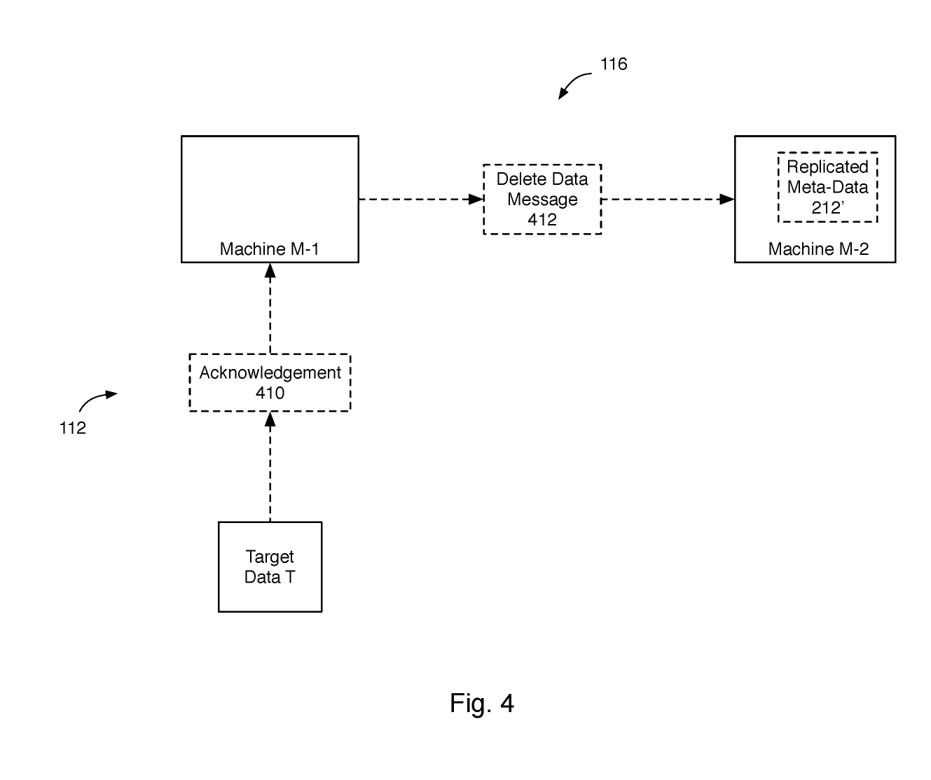

FIG. 4 shows how the machine M-1 deletes the replicated meta-data 212′ from the machine M-2 after receiving an acknowledgement 410 indicating the update of the target data T via the primary network 112 using the meta-data 212 is complete. In this example, the machine M-1 sends a delete data message 412 to the machine M-2 via the alternate network 116. The machine M-2 deletes the replicated meta-data 212′ in response to the delete data message 412.

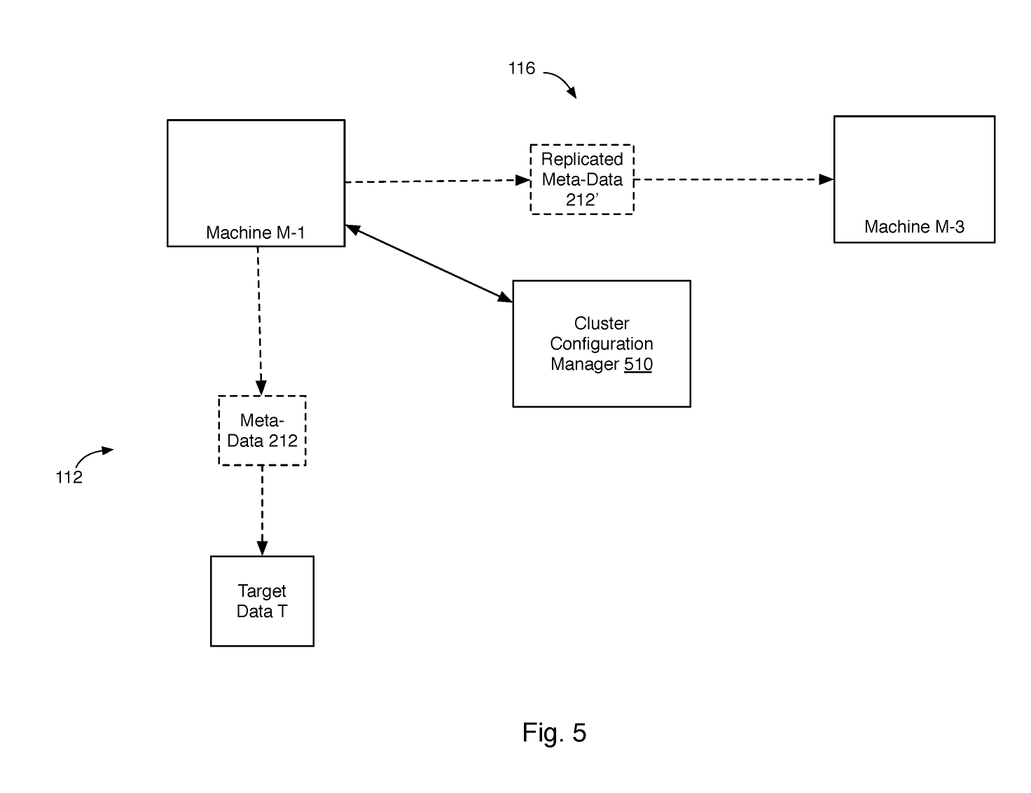

FIG. 5 shows how the machine M-1 replicates the meta-data 212 to the machine M-3 via the alternate network 116 if the machine M-2 is unavailable for handing the write request 210. The machine M-1 transfers the replicated meta-data 212′ to the machine M-3 while the update of the target data T via the primary network 112 using the meta-data 212 is still pending. The machine M-1 can also replicate one or more other sets of meta-data held in the machine M-2 to the machine M-3 via the alternate network 116 if the machine M-2 becomes unavailable. The machine M-1 deletes the replicated meta-data 212′ from the machine M-3 after receiving the acknowledgement 410 indicating the update of the target data T using the meta-data 212 is complete.

A machine in the cluster 110 can be unavailable if it, e.g., suffers a hardware or other failure. In one or more embodiments, the machine M-1 determines whether or not the machine M-2 is available by querying a cluster configuration manager 510. The cluster configuration manager 510 tracks the health of the machines M-1 through M-i in the cluster 110.

The machine M-1 can replicate the meta-data 212 to any of the machines M-2 through M-i which the cluster configuration manager 510 indicates is available when handling the write request 210. If none of the machines M-2 through M-i are available for handling the write request 210, the machine M-1 can handle the write request 210 without replication by waiting for completion of the update of the target data T with the meta-data 212 via the primary network 112 and then providing the acknowledgement 360 to the application program 250.

In one or more embodiments, the cluster configuration manager 510 tracks the reachability of the machines M-1 through M-i via the primary network 112 and the alternate network 116. In one or more embodiments, the cluster configuration manager 510 also tracks the state of the target data T, e.g., whether it is stored on one of the machines M-1 through M-i or on some other machine.

The cluster configuration manager 510 is informed of the state of the target data T as up-to-date when an application is no longer able to access the target data T, and all updates to target data T by the application have been already completed via the primary network 112. This may be the case when the application is cleanly removed from a machine, e.g., as a result of being shutdown at a machine or cleanly migrated away from machine. The cluster configuration manager 510 is also informed of the state of the target data T as being not-up-to-date as soon as an application issues its first write to the target data T before the first write is acknowledged to the application.

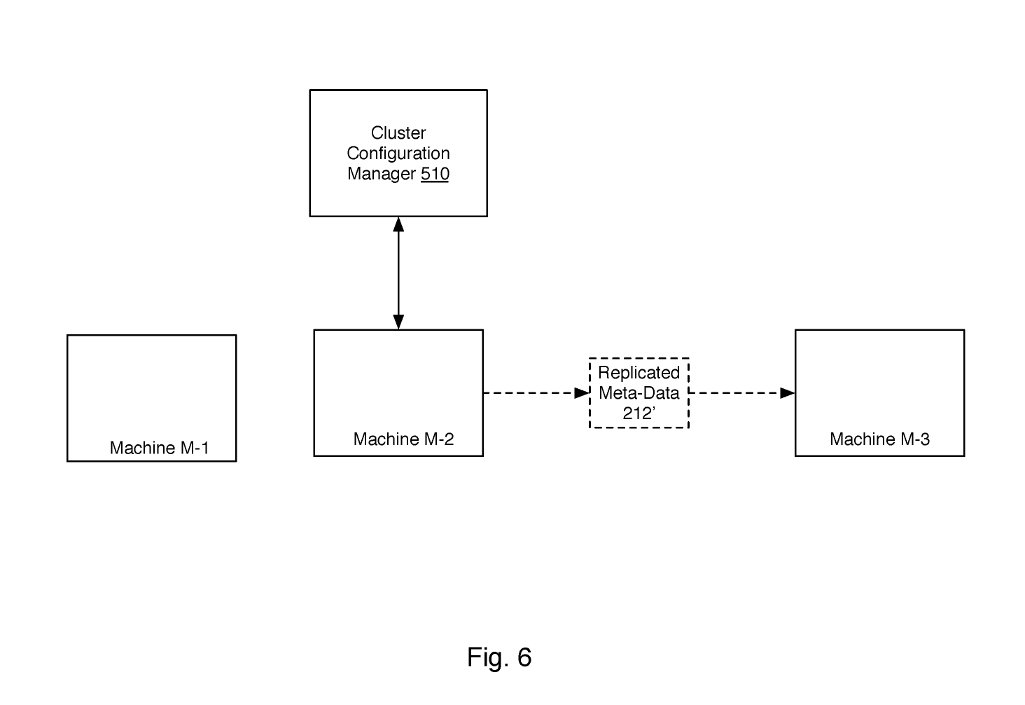

FIG. 6 shows how the machine M-2 replicates the replicated meta-data 212′ to the machine M-3 via the alternate network 116 if the machine M-1 becomes unavailable while the update of the target data T via the primary network 112 using the meta-data 112 is still pending. The machine M-2 can replicate the replicated meta-data 212′, which may be the last surviving copy, to any of the machines M-3 through M-i currently available as indicated by the cluster configuration manager 510.

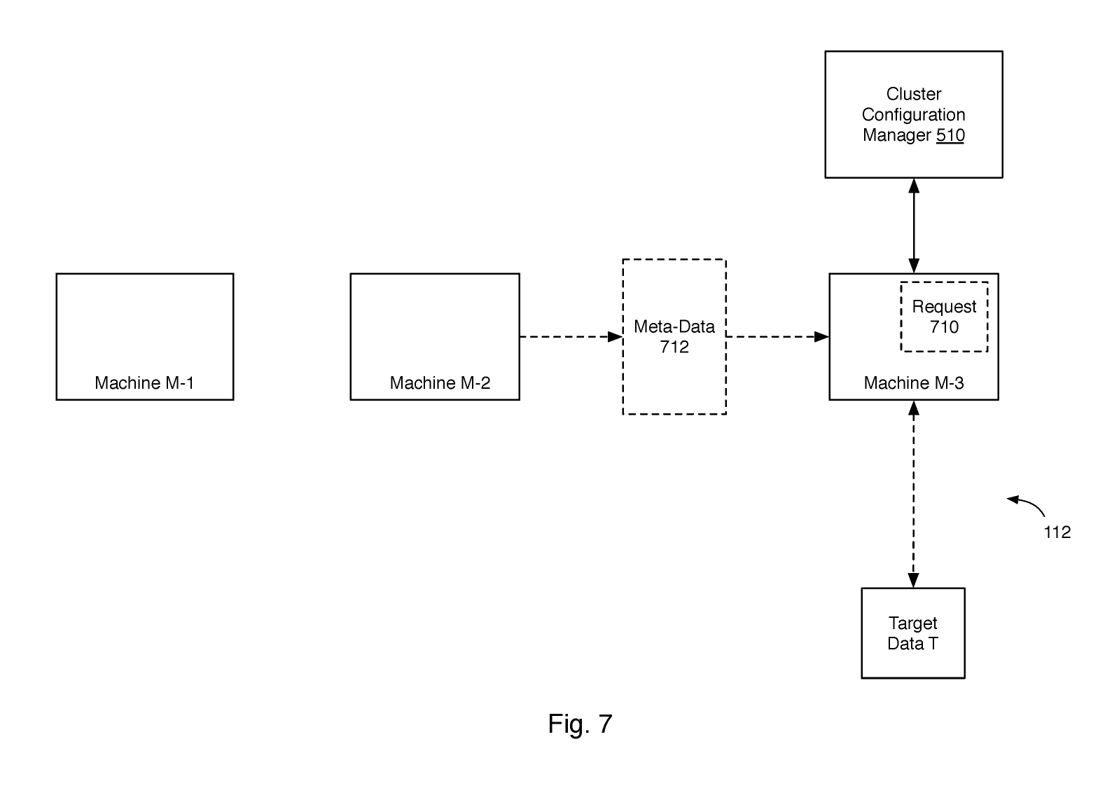

FIG. 7 shows how the machine M-3 handles a request 710 for the target data T when the machine M-2 still holds replicated meta-data. For example, the machine M-1 may have become unavailable before the update of the target data T with the meta-data 212 is complete or before deleting replicated meta-data from the machine M-2. The request 710 can be a read or a write request.

The machine M-3 handles the request 710 by checking the cluster configuration manager 510 for the state of the target data T. If the target data T is not up-to-date, a set of meta-data 712 for all pending writes to the target data T is retrieved from the machine M-2 and the machine M-3 updates the target data T accordingly. The meta-data 712 can include the replicated meta-data 212′ as well as other sets of replicated meta-data for updating the target data T.

If the request 710 is a write request, the machine M-3 can update the target data T via the primary network 112 using a set of meta-data describing the request 710 with or without replication of the meta-data describing the request 710 across the cluster 110 or early acknowledgement to the application program that issued the request 710.

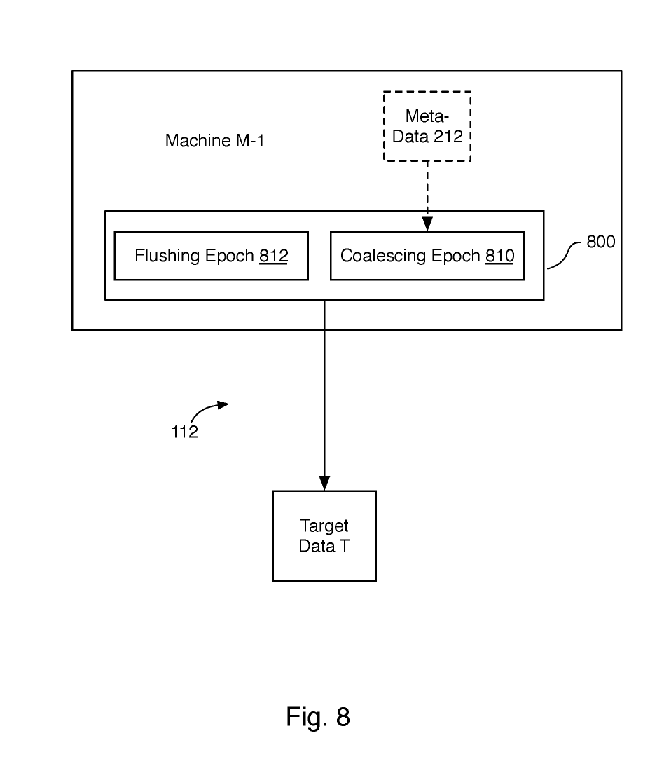

FIG. 8 illustrates a coalescing buffer 800 in the machine M-1 in one or more embodiments. Any of the machines M-1 through M-i can include a coalescing buffer. The coalescing buffer 800 includes a coalescing epoch 810 for coalescing the meta-data 212 with other meta-data for writing the target data T. For example, if a previous set of meta-data describing the same set of data as being described by meta-data 212 is already in the coalescing epoch 810 then the coalescing buffer 800 overwrites it with the meta-data 212. Otherwise, the coalescing buffer 800 creates a new entry in the coalescing epoch 810 for the meta-data 212. A background process on the machine M-1 can flush any meta-data stored in a flushing epoch 812 to the target data T via the primary network 112. At any time, the coalescing epoch 810 can become a flushing epoch and a new coalescing epoch created.

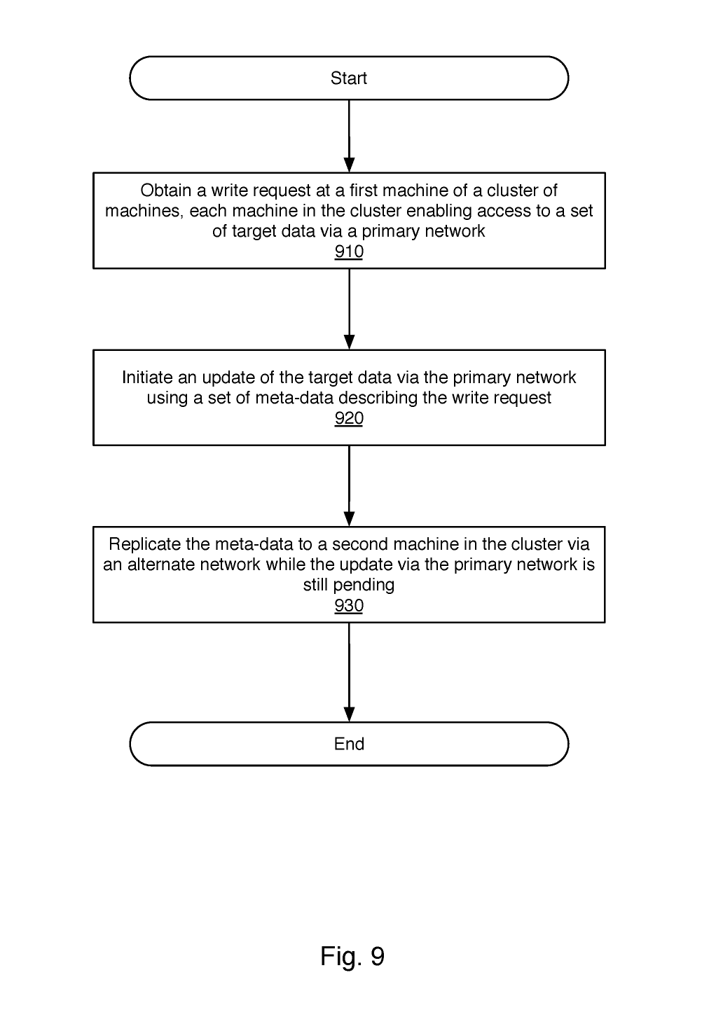

FIG. 9 illustrates a method for fault-tolerant storage in one or more embodiments. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 9 should not be construed as limiting the scope of the invention.

At step 910, a write request is obtained at a first machine of a cluster of machines. Each machine in the cluster can enable access to a set of target data via a primary network. The machines can include any combination of physical and virtual machines.

At step 920, an update of the target data is initiated via the primary network using a set of meta-data describing the write request. The target data can be updated using the hardware resources of the cluster or separate hardware.

At step 930, the meta-data describing the write request is replicated to a second machine in the cluster via an alternate network while the update via the primary network is still pending. The alternate network can be a virtual network physically shared with the primary network or a physically separate network from the primary network.

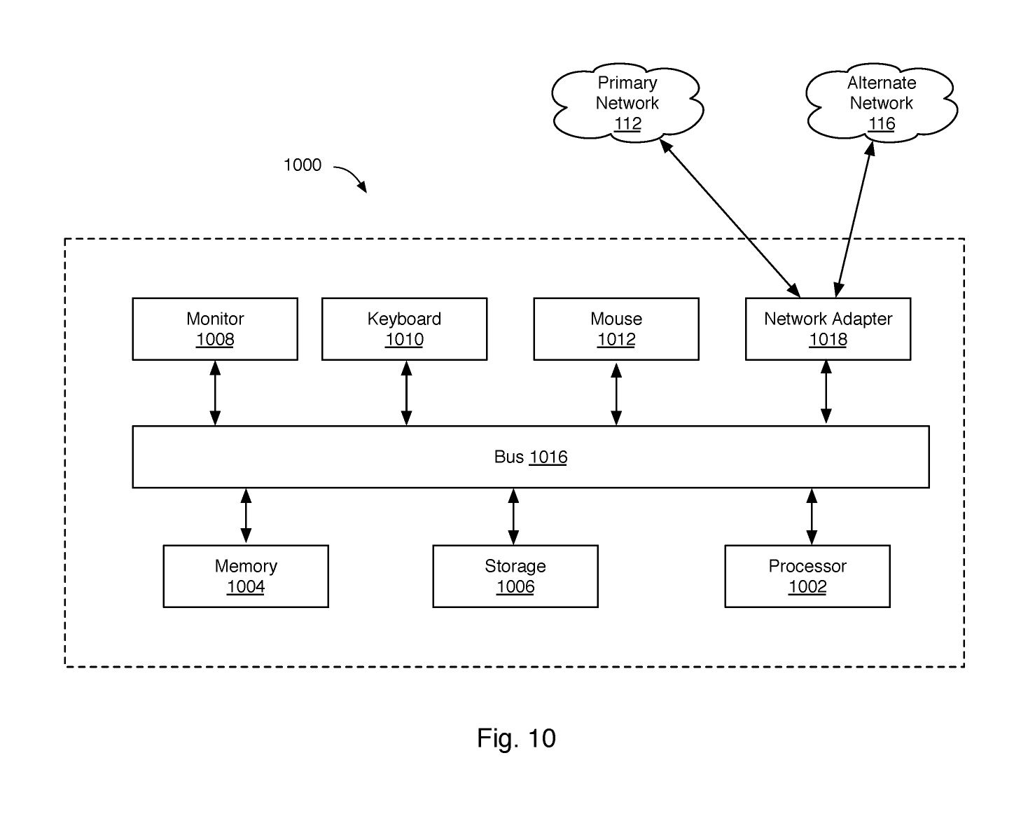

FIG. 10 illustrates a computing system 1000 upon which portions of the fault-tolerant storage system 100 can be implemented. The computing system 1000 includes one or more computer processor(s) 1002, associated memory 1004 (e.g., random access memory (RAM), cache memory, flash memory, etc.), one or more storage device(s) 1006 (e.g., a hard disk, an optical drive such as a compact disk (CD) drive or digital versatile disk (DVD) drive, a flash memory stick, etc.), a bus 1016, and numerous other elements and functionalities. The computer processor(s) 1002 may be an integrated circuit for processing instructions. For example, the computer processor(s) may be one or more cores or micro-cores of a processor. The computing system 1000 may also include one or more input device(s), e.g., a touchscreen, keyboard 1010, mouse 1012, microphone, touchpad, electronic pen, or any other type of input device. Further, the computing system 1000 may include one or more monitor device(s) 1008, such as a screen (e.g., a liquid crystal display (LCD), a plasma display, touchscreen, cathode ray tube (CRT) monitor, projector, or other display device), external storage, input for an electric instrument, or any other output device. The computing system 1000 may be connected to, e.g., a local area network (LAN), a wide area network (WAN) such as the Internet, mobile network, or any other type of network) via a network adapter 1018.

While the foregoing disclosure sets forth various embodiments using specific diagrams, flowcharts, and examples, each diagram component, flowchart step, operation, and/or component described and/or illustrated herein may be implemented, individually and/or collectively, using a range of processes and components.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While the invention has been described with respect to a limited number of embodiments, those skilled in the art, having benefit of this disclosure, will appreciate that other embodiments may be devised which do not depart from the scope of the invention as disclosed herein.

What is claimed is:

1. A fault-tolerant storage system, comprising:
a cluster of machines each enabling access to a set of target data via a primary network; and
an alternate network that enables communication among the machines in the cluster;
wherein a first machine in the cluster handles a write request by initiating an update of the target data via the primary network and replicating a set of meta-data describing the write request to a second machine in the cluster via the alternate network while the update via the primary network is still pending.

2. The fault-tolerant storage system of claim 1, wherein the first machine acknowledges the write request while the update via the primary network is still pending.

3. The fault-tolerant storage system of claim 2, wherein the first machine deletes the meta-data from the second machine after the update via the primary network is complete.

4. The fault-tolerant storage system of claim 1, wherein the first machine replicates the meta-data to a third machine in the cluster via the alternate network if the second machine is unavailable.

5. The fault-tolerant storage system of claim 4, wherein the first machine replicates one or more other sets of meta-data to the third machine via the alternate network if the second machine is unavailable.

6. The fault-tolerant storage system of claim 1, wherein the second machine replicates the meta-data to a third machine in the cluster via the alternate network if the first machine becomes unavailable while the update via the primary network is still pending.

7. The fault-tolerant storage system of claim 6, wherein the second machine replicates one or more other sets of meta-data to the third machine via the alternate network if the first machine becomes unavailable while the update via the primary network is still pending.

8. The fault-tolerant storage system of claim 1, wherein the first machine acknowledges the write request after the update via the primary network is complete if the machines in the cluster are unavailable for replicating the meta-data.

9. The fault-tolerant storage system of claim 1, wherein a third machine in the cluster handles a request for the target data by retrieving a set of meta-data for all pending writes to the target data from the second machine and updating the target data via the primary network.

10. The fault-tolerant storage system of claim 1, wherein the first machine includes a coalescing buffer including a coalescing epoch for coalescing the meta-data with a set of previous meta-data and a flushing epoch for flushing the meta-data to the target data via the primary network.

11. A method for fault-tolerant storage, comprising:
obtaining a write request at a first machine of a cluster of machines, each machine in the cluster enabling access to a set of target data via a primary network;
initiating an update of the target data via the primary network using a set of meta-data describing the write request; and
replicating the meta-data to a second machine in the cluster via an alternate network while the update via the primary network is still pending.

12. The method of claim 11, further comprising acknowledging the write request while the update via the primary network is still pending.

13. The method of claim 12, further comprising deleting the meta-data from the second machine after the update via the primary network is complete.

14. The method of claim 11, further comprising replicating the meta-data to a third machine in the cluster via the alternate network if the second machine is unavailable.

15. The method of claim 14, further comprising replicating one or more other sets of meta-data to the third machine via the alternate network if the second machine is unavailable.

16. The method of claim 11, further comprising replicating the meta-data to a third machine in the cluster via the alternate network if the first machine becomes unavailable while the update via the primary network is still pending.

17. The method of claim 16, further comprising replicating one or more other sets of meta-data to the third machine via the alternate network if the first machine becomes unavailable while the update via the primary network is still pending.

18. The method of claim 11, further comprising acknowledging the write request after the update via the primary network is complete if the machines in the cluster are unavailable for replicating the meta-data.

19. The method of claim 11, further comprising obtaining a request for the target data at a third machine in the cluster and in response retrieving a set of meta-data for all pending writes to the target data from the second machine and updating the target data via the primary network.

20. The method of claim 11, further comprising coalescing the meta-data with a set of previous meta-data and a flushing the meta-data to the target data via the primary network and flushing the meta-data to the target data via the primary network.
